(19) United States
(12) Patent Application Publication
(10) Pub. No.: US 2015/0107185 A1
(43) Pub. Date: Apr. 23, 2015

(54) WATERPROOF SCREW, SEALING MATERIAL, METHOD FOR STRUCTURE INSTALLATION, AND STRUCTURE FOR STRUCTURE INSTALLATION

(71) Applicant: NITTO DENKO CORPORATION, Osaka (JP)

(72) Inventors: Shinichiro Kose, Osaka (JP); Hiroki Fujii, Osaka (JP); Tetsuro Taga, Osaka (JP); Yoshiaki Mitsuoka, Osaka (JP)

(73) Assignee: NITTO DENKO CORPORATION, Osaka (JP)

(21) Appl. No.: 14/361,144

(22) PCT Filed: Nov. 19, 2012
(86) PCT No.: PCT/JP2012/079931

§ 371 Date: May 28, 2014

(30) Foreign Application Priority Data
Dec. 8, 2011 (JP) 2011-268728
Jun. 11, 2012 (JP) 2012-131706

(51) Int. Cl. F16B 43/00; E04F 13/21

(52) U.S. Cl. CPC F16B 43/001; E04F 13/21
USPC 52/741.1; 411/371.1

(57) ABSTRACT

A waterproof screw includes a screw member including a head portion and a shank portion and a sealing material covering the circumference of the shank portion. In the sealing material, the tackiness of a surface at the outer side in a radial direction of the shank portion is lower than that of a surface at the inner side in the radial direction thereof and the inner side in the radial direction of the sealing material has a shear storage elastic modulus G′ at 25° C. measured at a frequency of 1 Hz of 50000 Pa or less.

### TECHNICAL FIELD

The present invention relates to a waterproof screw, a sealing material, a method for structure installation, and a structure for structure installation, to be specific, to a waterproof screw used to install a structure on a roof of a building or the like, a sealing material, a method for structure installation, and a structure for structure installation.

### BACKGROUND ART

A structure such as a solar cell module is usually fixed to a roof of a building by a screw.

Thus, there may be a case where rain water or the like infiltrates through a screw hole formed in the roof into the inside of the roof, so that the roof is corroded.

In this way, a waterproof screw that is capable of fixing a structure and suppressing infiltration of water into the inside of a roof has been variously considered.

As such a waterproof screw, a screw having a rubber elastic material for water proof in its head portion has been proposed (ref: for example, the following Patent Document 1).

### PRIOR ART DOCUMENT

### Patent Document

Patent Document 1: Japanese Unexamined Patent Publication No. 2006-74068

### SUMMARY OF THE INVENTION

### Problems to be Solved by the Invention

Even when the structure is fixed to the roof using the screw described in the above-described Patent Document 1, however, there is a disadvantage that the rubber elastic material for water proof only seals the upper surface of the screw hole formed in the roof and fails to seal an insertion portion in the roof for the screw, so that the infiltration of water into the inside of the roof is not capable of being sufficiently suppressed.

It is an object of the present invention to provide a waterproof screw that is capable of fixing a structure to a roof; sealing an insertion portion for a shank portion; and sufficiently suppressing infiltration of water into the inside of the roof, a sealing material, a method for structure installation, and a structure for structure installation.

### Solution to the Problems

A waterproof screw of the present invention includes a screw member including a head portion and a shank portion and a sealing material covering the circumference of the shank portion, wherein in the sealing material, the tackiness of a surface at the outer side in a radial direction of the shank portion is lower than that of a surface at the inner side in the radial direction thereof and the inner side in the radial direction of the sealing material has a shear storage elastic modulus G′ at 25° C. measured at a frequency of 1 Hz of 50000 Pa or less.

In the waterproof screw of the present invention, it is preferable that the sealing material includes an inner-side elastic layer in contact with the shank portion and an outer-side elastic layer laminated at the outer side in the radial direction of the inner-side elastic layer, the inner-side elastic layer has a shear storage elastic modulus G′ at 25° C. measured at a frequency of 1 Hz of 50000 Pa or less, and the shear storage elastic modulus G′ of the outer-side elastic layer is higher than that of the inner-side elastic layer.

In the waterproof screw of the present invention, it is preferable that the outer-side elastic layer has a shear storage elastic modulus G′ at 25° C. measured at a frequency of 1 Hz of 1000000 Pa or less.

In the waterproof screw of the present invention, it is preferable that the inner-side elastic layer has a 180° peel adhesive force at 23° C. with respect to a stainless steel board of 5 N/25 mm or more.

In the waterproof screw of the present invention, it is preferable that the outer-side elastic layer has a 180° peel adhesive force at 23° C. with respect to a stainless steel board of 1 N/25 mm or less.

In the waterproof screw of the present invention, it is preferable that the inner-side elastic layer contains a butyl rubber.

In the waterproof screw of the present invention, it is preferable that the outer-side elastic layer contains a synthetic rubber and/or a resin.

In the waterproof screw of the present invention, it is preferable that the synthetic rubber is an ethylene-propylene-diene rubber.

In the waterproof screw of the present invention, it is preferable that the inner-side elastic layer further contains a liquid rubber and a filler and the mixing ratio of the filler with respect to 100 parts by mass of the butyl rubber is less than 300 parts by mass.

In the waterproof screw of the present invention, it is preferable that the waterproof screw is used so as to install a structure on a roof.

A sealing material of the present invention covers a shank portion of a screw member to be used so as to seal an insertion portion for the shank portion, wherein in a state of covering the shank portion, the tackiness of a surface at the outer side in a radial direction of the shank portion is lower than that of a surface at the inner side in the radial direction thereof and the inner side in the radial direction of the sealing material has a shear storage elastic modulus G′ at 25° C. measured at a frequency of 1 Hz of 50000 Pa or less.

A method for structure installation of the present invention, installing a structure on a roof, includes a structure disposing step of disposing the structure on the roof and a structure fixing step of fixing the structure to the roof by the above-described waterproof screw.

A structure for structure installation of the present invention in which a structure is installed on a roof, wherein the structure is disposed on the roof and the structure is fixed to the roof by the above-described waterproof screw.

### Effect of the Invention

The waterproof screw of the present invention includes a screw member including a head portion and a shank portion and a sealing material covering the circumference of the shank portion, and the inner side in the radial direction of the shank portion in the sealing material has a shear storage elastic modulus G′ at 25° C. measured at a frequency of 1 Hz of 50000 Pa or less. Thus, when a structure is fixed to a roof using the waterproof screw of the present invention, the sealing material is capable of sealing an insertion portion in the roof for the shank portion, so that infiltration of water into the inside of the roof is capable of being sufficiently suppressed.

In the waterproof screw of the present invention, in the sealing material, the tackiness of the surface at the outer side in the radial direction of the shank portion is lower than that of the surface at the inner side in the radial direction thereof, so that the blocking resistance is excellent and the blocking (the adhesion of the sealing materials to each other) of the waterproof screws with each other at the time of transportation or the like is capable of being suppressed. Furthermore, the waterproof screw of the present invention has excellent handling ability, so that the adhesion of the sealing material to a hand or the like of an operator is capable of being suppressed at the time of an installation operation of installing a structure on a roof.

Thus, in the waterproof screw of the present invention, a release paper is not required and a step of peeling the release paper is capable of being omitted at the time of the installation operation of installing the structure on the roof, so that a smooth installation operation of the structure is capable of being achieved, that is, the improvement of the workability is capable of being achieved.

Consequently, since the waterproof screw has excellent blocking resistance and excellent handling ability, the waterproof screw, the sealing material, the method for structure installation, and the structure for structure installation of the present invention are capable of fixing the structure to the roof with excellent workability and sufficiently suppressing the infiltration of water into the inside of the roof.

### BRIEF DESCRIPTION OF THE DRAWINGS

FIG. 1 shows a side sectional view of one embodiment of a waterproof screw of the present invention.

FIG. 2 shows a side sectional view of one embodiment of a sealing material used in a waterproof screw of the present invention.

FIG. 3 shows process drawings for illustrating one embodiment of a method for producing the sealing material shown in FIG. 2:

(a) illustrating a step of preparing an inner-side elastic layer,

(b) illustrating a step of preparing an outer-side elastic layer,

(c) illustrating a step of attaching the inner-side elastic layer to the outer-side elastic layer, and

(d) illustrating a step of fabricating the sealing material.

FIG. 4 shows explanatory views for illustrating one embodiment of a method for structure installation of the present invention in which a structure is installed on a roof of a building:

(a) illustrating a structure disposing step of disposing the structure on the roof and

(b) to (e) illustrating a structure fixing step of fixing the structure to the roof by the waterproof screw shown in FIG. 1.

FIG. 5 shows a side view of another embodiment (an embodiment including a support layer) of a sealing material used in a waterproof screw of the present invention.

FIG. 6 shows explanatory views for illustrating evaluation criteria in a screw adhesiveness test:

(a) illustrating a case of having a good screw adhesiveness and

(b) illustrating a case of having a bad screw adhesiveness.

FIG. 7 shows explanatory views for illustrating evaluation criteria in a roofing material adhesiveness test:

(a) illustrating a case of having a good roofing material adhesiveness and

(b) illustrating a case of having a bad roofing material adhesiveness.

FIG. 8 shows an explanatory view for illustrating a test method of a water stopping test of screw in Examples and Comparative Examples.

### EMBODIMENT OF THE INVENTION

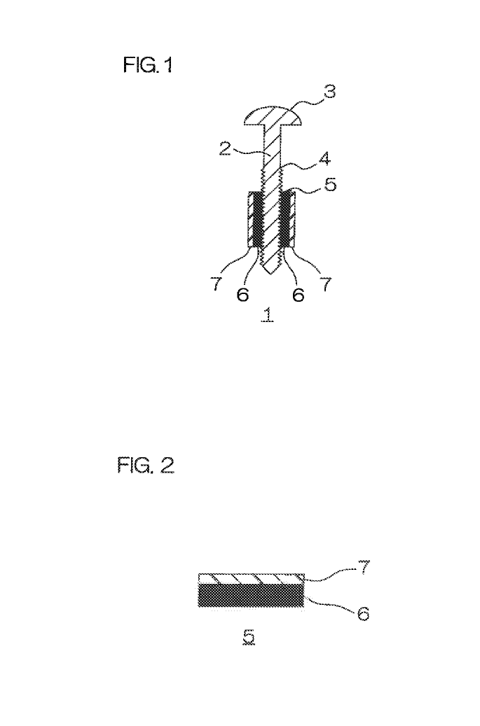

FIG. 1 shows a side sectional view of one embodiment of a waterproof screw of the present invention.

A waterproof screw 1 is a screw having a waterproof function that prevents infiltration of water into the inside of a screw hole. The waterproof screw 1 includes a screw member 2 and a sealing material 5.

The screw member 2 is a known screw member that is provided with a head portion 3 and a shank portion 4 at which a screw thread (a screw groove) is formed. The screw member 2 is not particularly limited and examples thereof include a wood screw and a metal screw. Preferably, a metal screw is used.

The sealing material 5 is used so as to cover the circumference of the shank portion 4 of the screw member 2 and to seal an insertion portion for the shank portion 4.

In the sealing material 5, the tackiness of a surface at the outer side in a radial direction of the shank portion 4 is, in view of improvement of workability and storage stability, adjusted to be lower than that of a surface at the inner side in the radial direction thereof, or preferably to be tack-free.

In the sealing material 5, the reference for tackiness is the pressure-sensitive adhesive properties. For example, it is judged that the higher the 180° peel adhesive force at 23° C. with respect to a stainless steel board is, the higher the tackiness is.

To be specific, in the sealing material 5, the surface at the inner side in the radial direction of the shank portion 4 has a 180° peel adhesive force at 23° C. with respect to a stainless steel board of, for example, 5 N/25 mm or more, preferably 8.0 N/25 mm or more, or more preferably 10.0 N/25 mm or more, and of, usually, less than 50.0 N/25 mm.

On the other hand, in the sealing material 5, the 180° peel adhesive force at 23° C. with respect to a stainless steel board of the surface at the outer side in the radial direction of the shank portion 4 is lower than the above-described peel adhesive force of the surface at the inner side in the radial direction thereof and is, for example, 1 N/25 mm or less, preferably 0.8 N/25 mm or less, or more preferably 0.5 N/25 mm or less, and is, usually, 0.01 N/25 mm or more.

The peel adhesive force is calculated by a peel adhesive property test to be described in detail in Examples (hereinafter, the same).

The sealing material 5 in the inner side in the radial direction of the shank portion 4 (a portion including the surface at the inner side in the radial direction of the sealing material 5) has a shear storage elastic modulus G′ at 25° C. measured at a frequency of 1 Hz of 50000 Pa or less, or preferably 40000 Pa or less, and of, for example, 10000 Pa or more, or preferably 15000 Pa or more.

In the outer side in the radial direction of the shank portion 4 (a portion including the surface at the outer side in the radial direction of the sealing material 5), the shear storage elastic modulus G′ at 25° C. measured at a frequency of 1 Hz is higher than the above-described shear storage elastic modulus G′ of the surface at the inner side in the radial direction thereof and is, for example, 1000000 Pa or less, or preferably 800000 Pa or less, and is, for example, above 50000 Pa, or preferably 100000 Pa or more.

The shear storage elastic modulus G′ is calculated by a viscoelasticity test to be described in detail in Examples (hereinafter, the same).

The sealing material 5 in the inner side in the radial direction of the shank portion 4 has a shear loss elastic modulus G″ at 25° C. measured at a frequency of 1 Hz of, for example, 20000 Pa or less, or preferably 18000 Pa or less, and of, for example, 5000 Pa or more, or preferably 10000 Pa or more.

The sealing material 5 in the outer side in the radial direction of the shank portion 4 has a shear loss elastic modulus G″ at 25° C. measured at a frequency of 1 Hz of, for example, 200000 Pa or less, or preferably 180000 Pa or less, and of, for example, 50000 Pa or more, or preferably 80000 Pa or more.

The shear loss elastic modulus G″ is calculated with the above-described shear storage elastic modulus G′ (hereinafter, the same).

A method for adjusting the tackiness (that is, the pressure-sensitive adhesive properties) of the surface of the sealing material 5 is not particularly limited and the sealing material 5 may be, for example, formed as a plurality of layers (for example, two layers) by attaching a plurality of (for example, two) layers each having different tackiness. Or, for example, the sealing material 5 may be covered with powders by applying the powders for reducing the tackiness to the surface at the outer side in the radial direction of the sealing material 5. Or furthermore, for example, the tackiness is capable of being reduced by heating the outermost surface in the radial direction of the shank portion 4 to be dried and cured in the sealing material 5.

Preferably, the sealing material 5 is formed by attaching a plurality of (for example, two) layers each having different tackiness.

To be specific, in FIG. 1, the sealing material 5 includes an inner-side elastic layer 6 that is in contact with the shank portion 4 and an outer-side elastic layer 7 that is laminated at the outer side in the radial direction of the inner-side elastic layer 6 and has a higher shear storage elastic modulus G′ than that of the inner-side elastic layer 6.

The 180° peel adhesive force at 23° C. with respect to a stainless steel board of the inner-side elastic layer 6 is higher than the peel adhesive force of the outer-side elastic layer 7 to be described later and is, for example, 5 N/25 mm or more, preferably 8.0 N/25 mm or more, or more preferably 10.0 N/25 mm or more, and is, usually, less than 50.0 N/25 mm.

When the peel adhesive force of the inner-side elastic layer 6 is within the above-described range, the sealing material 5 is sufficiently brought into tight contact with the shank portion 4 and an insertion portion is capable of being sealed at the time of fixing the waterproof screw 1.

The shear storage elastic modulus G′ of the inner-side elastic layer 6 is lower than that of the outer-side elastic layer 7 to be described later. To be specific, the inner-side elastic layer 6 has a shear storage elastic modulus G′ at 25° C. measured at a frequency of 1 Hz of, 50000 Pa or less, or preferably 40000 Pa or less, and of, for example, 10000 Pa or more, or preferably 15000 Pa or more.

When the shear storage elastic modulus G′ of the inner-side elastic layer 6 is within the above-described range, the sealing material 5 sufficiently follows the shank portion 4 and an insertion portion is capable of being sealed at the time of fixing the waterproof screw 1.

The inner-side elastic layer 6 has a shear loss elastic modulus G″ at 25° C. measured at a frequency of 1 Hz of, for example, 20000 Pa or less, or preferably 18000 Pa or less, and of, for example, 5000 Pa or more, or preferably 10000 Pa or more.

The inner-side elastic layer 6 preferably contains a butyl rubber in view of improvement of the adhesiveness and the followability of the waterproof screw 1 with respect to the shank portion 4 and improvement of the water stopping performance after sealing an insertion portion.

The butyl rubber is a copolymer (an isobutylene-isoprene rubber) of isobutene (isobutylene) and a small amount of isoprene.

The butyl rubber has a Mooney viscosity of, for example, 30 (ML 1+4, 100° C.) or more, or preferably 40 (ML 1+4, 100° C.) or more, and of, for example, 70 (ML 1+4, 100° C.) or less, or preferably 60 (ML 1+4, 100° C.) or less.

An example of the butyl rubber includes a known butyl rubber such as a reclaimed butyl rubber.

The mixing ratio of the butyl rubber with respect to the total amount of the inner-side elastic layer 6 is, for example, 10 mass % or more, or preferably 20 mass % or more, and is, for example, 50 mass % or less, or preferably 40 mass % or less.

Preferably, the inner-side elastic layer 6 further contains a liquid rubber in view of reduction of the shear storage elastic modulus G′.

The liquid rubber is a rubber in a liquid state at a normal temperature that is compatible with the butyl rubber. Examples thereof include a liquid isoprene rubber, a liquid butadiene rubber, and polybutene (to be specific, liquid polybutene).

These liquid rubbers can be used alone or in combination.

Of the liquid rubbers, preferably, polybutene is used.

The polybutene has a kinetic viscosity at 40° C. of, for example, 10 mm²/s or more, or preferably 1000 mm²/s or more, and of, for example, 200000 mm²/s or less, or preferably 100000 mm²/s or less. The polybutene has a kinetic viscosity at 100° C. of, for example, 2.0 mm²/s or more, or preferably 50 mm²/s or more, and of, for example, 4000 mm²/s or less, or preferably 2000 mm²/s or less.

The mixing ratio of the liquid rubber with respect to the total amount of the inner-side elastic layer 6 is, for example, 10 mass % or more, or preferably 20 mass % or more, and is, for example, 50 mass % or less, or preferably 40 mass % or less. The mixing ratio of the liquid rubber with respect to 100 parts by mass of the butyl rubber is, for example, 70 parts by mass or more, or preferably 80 parts by mass or more, and is, for example, 140 parts by mass or less, or preferably 120 parts by mass or less.

By blending the polybutene, the butyl rubber is capable of being softened.

Preferably, the inner-side elastic layer 6 further contains a filler and a tackifier in view of improvement of the adhesiveness of the waterproof screw 1 with respect to the shank portion 4.

Examples of the filler include calcium carbonate (for example, heavy calcium carbonate, light calcium carbonate, Hakuenka, and the like), talc, mica, clay, mica powder, silica, alumina, aluminum silicate, titanium oxide, and glass powder (powder).

These fillers can be used alone or in combination.

Of the fillers, preferably, calcium carbonate is used.

The mixing ratio of the filler with respect to the total amount of the inner-side elastic layer 6 is, for example, 10 mass % or more, or preferably 20 mass % or more, and is, for example, 50 mass % or less, or preferably 40 mass % or less. The mixing ratio of the filler with respect to 100 parts by mass of the butyl rubber is, for example, less than 300 parts by mass, or preferably 250 parts by mass or less, and is, for example, 10 parts by mass or more, or preferably 30 parts by mass or more.

When the mixing proportion of the filler is within the above-described range, the improvement of the adhesiveness of the waterproof screw 1 with respect to the shank portion 4 is capable of being achieved.

Examples of the tackifier include a rosin-based resin, a terpene-based resin (for example, a terpene-aromatic liquid resin and the like), a coumarone indene resin, and a petroleum resin (for example, a C5 petroleum resin and the like).

These tackifiers can be used alone or in combination.

Of the tackifiers, preferably, a petroleum resin such as a C5 petroleum resin (a C5 tackifier) is used.

The mixing ratio of the tackifier with respect to the total amount of the inner-side elastic layer 6 is, for example, 5 mass % or more, or preferably 10 mass % or more, and is, for example, 25 mass % or less, or preferably 20 mass % or less. The mixing ratio of the tackifier with respect to 100 parts by mass of the butyl rubber is, for example, 20 parts by mass or more, or preferably 40 parts by mass or more, and is, for example, 80 parts by mass or less, or preferably 60 parts by mass or less.

In addition to the above-described component, a cross-linking agent and furthermore, if necessary, a known additive can be also added to the inner-side elastic layer 6 at an appropriate proportion. Examples of the known additive include a foaming agent, an anti-sagging agent (a thixotropic-imparting agent), a low-polarity rubber, a pigment, a thixotropic agent, a lubricant, an anti-scorching agent, a stabilizer, and an oxidation inhibitor.

Examples of the cross-linking agent include sulfur, a peroxide-based cross-linking agent, a metal chelate-based cross-linking agent, a quinoid cross-linking agent, an epoxy cross-linking agent, an isocyanate cross-linking agent, a metal salt-based cross-linking agent, a melamine cross-linking agent, an amino cross-linking agent, and a coupling agent-based cross-linking agent (a silane coupling agent or the like).

These cross-linking agents can be used alone or in combination.

Of the cross-linking agents, preferably, a quinoid cross-linking agent is used.

The mixing ratio of the cross-linking agent with respect to the total amount of the inner-side elastic layer 6 is, for example, 0.01 mass % or more, or preferably 0.1 mass % or more, and is, for example, 2.0 mass % or less, or preferably 1.0 mass % or less. The mixing ratio of the cross-linking agent with respect to 100 parts by mass of the butyl rubber is, for example, 0.5 parts by mass or more, or preferably 1 part by mass or more, and is, for example, 10 parts by mass or less, or preferably 5 parts by mass or less.

The inner-side elastic layer 6 has a thickness (a thickness in the radial direction) of, for example, 0.5 mm or more, and of, for example, 5 mm or less, preferably 3 mm or less, or more preferably 1.5 mm or less.

The 180° peel adhesive force at 23° C. with respect to a stainless steel board of the outer-side elastic layer 7 is lower than the peel adhesive force of the inner-side elastic layer 6 described above and is, for example, 1 N/25 mm or less, preferably 0.8 N/25 mm or less, or more preferably 0.5 N/25 mm or less, and is, usually, 0.01 N/25 mm or more.

When the peel adhesive force of the outer-side elastic layer 7 is within the above-described range, the blocking of the waterproof screws 1 with each other is capable of being sufficiently suppressed.

The shear storage elastic modulus G′ of the outer-side elastic layer 7 is higher than that of the inner-side elastic layer 6 described above. To be specific, the outer-side elastic layer 7 has a shear storage elastic modulus G′ at 25° C. measured at a frequency of 1 Hz of, for example, 1000000 Pa or less, or preferably 800000 Pa or less, and of, for example, above 50000 Pa, or preferably 100000 Pa or more.

When the shear storage elastic modulus G′ of the outer-side elastic layer 7 is within the above-described range, the sealing material 5 is sufficiently fixed to the lower surface of the head portion 3 and the upper side of a structure 8 is capable of being sealed at the time of fixing the waterproof screw 1.

The outer-side elastic layer 7 has a shear loss elastic modulus U′ at 25° C. measured at a frequency of 1 Hz of, for example, 200000 Pa or less, or preferably 180000 Pa or less, and of, for example, 50000 Pa or more, or preferably 80000 Pa or more.

The outer-side elastic layer 7 is not particularly limited and preferably contains a synthetic rubber and/or a resin in view of sealing properties of the lower surface of the head portion 3.

Examples of the synthetic rubber include an ethylene-propylene-diene rubber (EPDM); an α-olefin such as 1-butene and dicyclopentadiene; a rubber-based copolymer containing a component of a cyclic or non-cyclic polyene having a non-conjugated double bond such as ethylidene norbornene; an ethylene-propylene rubber; an ethylene-propylene terpolymer; a silicone rubber; a polyurethane-based rubber; and a polyamide-based rubber.

These synthetic rubbers can be used alone or in combination of two or more.

A preferable example of the synthetic rubber includes an ethylene-propylene-diene rubber.

When the ethylene-propylene-diene rubber is used, the improvement of the weather resistance is capable of being achieved.

The ethylene-propylene-diene rubber has a Mooney viscosity of, for example, 10 (ML 1+4, 100° C.) or more, or preferably 20 (ML 1+4, 100° C.) or more, and of, for example, 60 (ML 1+4, 100° C.) or less, or preferably 50 (ML 1+4, 100° C.) or less.

Examples of the resin include a thermosetting resin and a thermoplastic resin.

Examples of the thermosetting resin include an epoxy resin, a urethane resin, a melamine resin, and a phenol resin.

Examples of the thermoplastic resin include polyethylene, polypropylene, a vinyl acetate resin, an ethylene-vinyl acetate copolymer (EVA), a vinyl chloride resin, and an EVA-vinyl chloride resin copolymer.

These resins can be used alone or in combination of two or more.

Preferably, the outer-side elastic layer 7 further contains a butyl rubber in view of improvement of the water stopping performance of the lower surface of the head portion 3.

An example of the butyl rubber includes the above-described butyl rubber. Preferably, an example thereof includes the same butyl rubber as that contained in the inner-side elastic layer 6.

The mixing ratio of the butyl rubber with respect to the total amount of the outer-side elastic layer 7 is, for example, 10 mass % or more, or preferably 15 mass % or more, and is, for example, 50 mass % or less, or preferably 40 mass % or less. The mixing ratio of the butyl rubber with respect to 100 parts by mass of the total amount of the synthetic rubber and/or the resin is, for example, 60 parts by mass or more, or preferably 80 parts by mass or more, and is, for example, 140 parts by mass or less, or preferably 120 parts by mass or less.

Preferably, the outer-side elastic layer 7 further contains a softener and a filler in view of sealing properties of the lower surface of the head portion 3.

Examples of the softener include drying oils, animal and vegetable oils (for example, linseed oil and the like), paraffin, asphalts, petroleum oils (for example, paraffinic process oil, naphthenic process oil, aromatic process oil, and the like), low molecular weight polymers, organic acid esters (for example, phthalic ester (for example, di-2-ethylhexyl phthalate (DOP) and dibutyl phthalate (DBP)), phosphate ester, higher fatty acid ester, alkyl sulfonate ester, and the like), and a thickener. Preferably, paraffin, asphalts, and petroleum oils are used.

These softeners can be used alone or in combination of two or more.

The mixing ratio of the softener with respect to the total amount of the outer-side elastic layer 7 is, for example, 1 mass % or more, or preferably 2 mass % or more, and is, for example, 15 mass % or less, or preferably 10 mass % or less. The mixing ratio of the softener with respect to 100 parts by mass of the total amount of the synthetic rubber and/or the resin is, for example, 10 parts by mass or more, or preferably 20 parts by mass or more, and is, for example, 100 parts by mass or less, or preferably 80 parts by mass or less.

When the mixing proportion of the softener is within the above-described range, the improvement of the sealing properties of the lower surface of the head portion 3 is capable of being achieved.

An example of the filler includes the above-described filler. Preferably, calcium carbonate is used.

The mixing ratio of the filler with respect to the total amount of the outer-side elastic layer 7 is, for example, 20 mass % or more, or preferably 30 mass % or more, and is, for example, 80 mass % or less, or preferably 70 mass % or less. The mixing ratio of the filler with respect to 100 parts by mass of the total amount of the synthetic rubber and/or the resin is, for example, 20 parts by mass or more, or preferably 50 parts by mass or more, and is, for example, 300 parts by mass or less, or preferably 200 parts by mass or less.

When the mixing proportion of the filler is within the above-described range, the improvement of the sealing properties of the lower surface of the head portion 3 is capable of being achieved.

In addition to the above-described component, furthermore, if necessary, a known additive can be also added to the outer-side elastic layer 7 at an appropriate proportion. Examples of the known additive include a cross-linking agent, a foaming agent, an anti-sagging agent (a thixotropic-imparting agent), a low-polarity rubber, a pigment, a thixotropic agent, a lubricant, an anti-scorching agent, a stabilizer, and an oxidation inhibitor.

The outer-side elastic layer 7 has a thickness of, for example, 0.1 mm or more, or preferably 0.3 mm or more, and of, for example, 1.0 mm or less, or preferably 0.8 mm or less.

The sealing material 5 has a thickness (the sum total of the thickness of the inner-side elastic layer 6 and that of the outer-side elastic layer 7) of, for example, 0.5 mm or more, and of, for example, 5 mm or less, preferably 3 mm or less, or more preferably 1.5 mm or less.

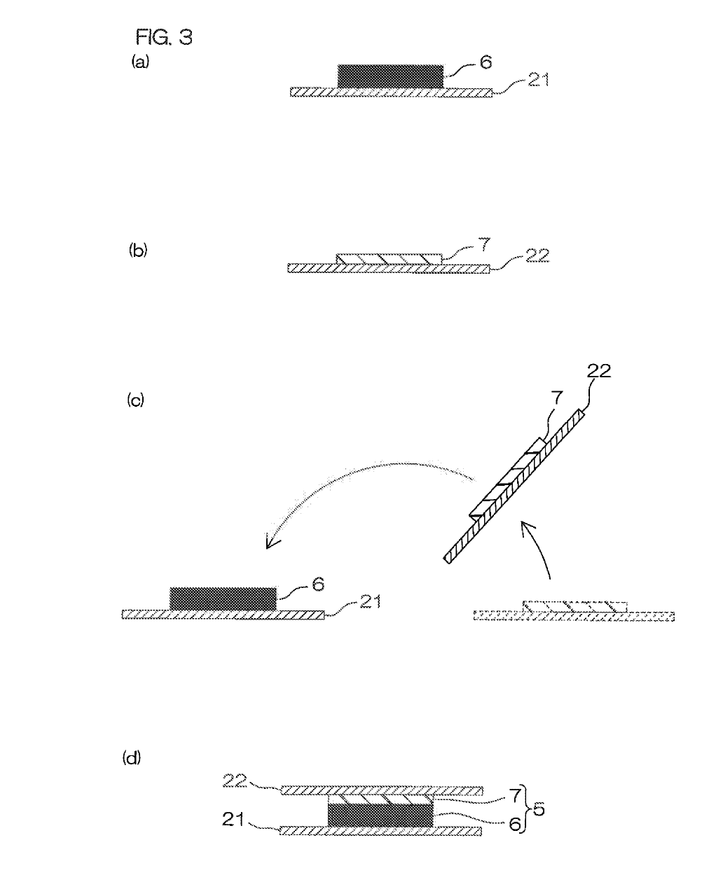

FIG. 2 shows a side sectional view of one embodiment of a sealing material used in a waterproof screw of the present invention. FIG. 3 shows process drawings for illustrating one embodiment of a method for producing the sealing material shown in FIG. 2.

Next, a fabrication method of the waterproof screw 1 of the present invention is described with reference to FIGS. 2 and 3.

In order to fabricate the waterproof screw 1, first, as shown in FIG. 2, the sealing material 5 is fabricated.

In order to fabricate the sealing material 5, first, as shown in FIG. 3 (a), the inner-side elastic layer 6 is prepared.

In order to prepare the inner-side elastic layer 6, for example, the above-described components are blended at the above-described mixing proportion and are kneaded with, though not particularly limited, for example, a mixing roll, a pressure kneader, an extruder, or the like, so that a pressure-sensitive adhesive composition is obtained.

When a cross-linking agent is added to the pressure-sensitive adhesive composition, the adding is performed at a temperature at which the pressure-sensitive adhesive composition is cross-linked in the above-described kneading or the following extension by applying pressure.

Thereafter, the obtained pressure-sensitive adhesive composition is extended by applying pressure by, for example, a calendering, an extrusion molding, a press molding, or the like to be laminated on the surface of a first release paper 21 or the like. In this way, the inner-side elastic layer 6 is prepared into a sheet shape.

As described above, the inner-side elastic layer 6 has a thickness of, for example, 0.5 mm or more, and of, for example, 5 mm or less, preferably 3 mm or less, or more preferably 1.5 mm or less.

In this method, as shown in FIG. 3 (b), the outer-side elastic layer 7 is prepared along with the above-described preparation of the inner-side elastic layer 6.

In order to prepare the outer-side elastic layer 7, for example, the above-described components are blended at the above-described mixing proportion and are kneaded with, though not particularly limited, for example, a mixing roll, a pressure kneader, an extruder, or the like, so that a low pressure-sensitive adhesive composition is obtained.

Thereafter, the obtained low pressure-sensitive adhesive composition is extended by applying pressure by, for example, a calendering, an extrusion molding, a press molding, or the like to be laminated on the surface of a second release paper 22 or the like. In this way, the outer-side elastic layer 7 is prepared into a sheet shape.

As described above, the outer-side elastic layer 7 has a thickness of, for example, 0.1 mm or more, or preferably 0.3 mm or more, and of, for example, 1.0 mm or less, or preferably 0.8 mm or less.

Thereafter, in this method, as shown in FIG. 3 (c), the inner-side elastic layer 6 and the outer-side elastic layer 7 that are prepared as described above are attached to each other and as shown in FIG. 3 (d), the sealing material 5 is fabricated. At this time, both surfaces of the top surface and the back surface of the sealing material 5 are covered with the release papers (the first release paper 21 and the second release paper 22).

As described above, the obtained sealing material 5 has a thickness (the sum total of the thickness of the inner-side elastic layer 6 and that of the outer-side elastic layer 7) of, for example, 0.5 mm or more, and of, for example, 5 mm or less, preferably 3 mm or less, or more preferably 1.5 mm or less.

Next, in this method, the above-described sealing material 5 is wound around the shank portion 4 of the screw member 2 described above, so that the waterproof screw 1 is fabricated.

That is, in this method, first, the first release paper 21 is peeled and the inner-side elastic layer 6 is exposed. Next, the shank portion 4 is brought into contact with the inner-side elastic layer 6 so that the second release paper 22 is located at the outermost layer (the topmost surface) and the sealing material 5 is wound around the shank portion 4 of the screw member 2. To be more specific, the sealing material 5 is wound around the shank portion 4 so as to cover the screw thread (the screw groove) thereof along the outer circumference surface thereof. In this way, the sealing material 5 covers the circumference of the shank portion 4.

Thereafter, the second release paper 22 is peeled, so that the outer-side elastic layer 7 is exposed as the outermost layer (the topmost surface).

The winding method of the sealing material 5 is not limited to the above-described method. Alternatively, for example, the first release paper 21 and the second release paper 22 are simultaneously peeled from the sealing material 5 and the inner-side elastic layer 6 and the outer-side elastic layer 7 are exposed. Thereafter, the shank portion 4 is brought into contact with the inner-side elastic layer 6 and the sealing material 5 is also capable of being wound around the shank portion 4 of the screw member 2.

At this time, the sealing material 5 covers the shank portion 4 in an axial direction of the shank portion 4 at a ratio of, for example, 20% or more, or preferably 30% or more, and of, for example, 90% or less, or preferably 80% or less with respect to the total length of the shank portion 4. To be specific, though the ratio is appropriately selected in accordance with the length of the insertion portion for the shank portion 4, the sealing material 5 covers the shank portion 4 by, for example, 20 to 100 mm.

The sealing material 5 covers the shank portion 4 with a length longer than that of the insertion portion for the shank portion 4, for example, in the axial direction of the shank portion 4, with a length longer than that of the insertion portion for the shank portion 4 by, for example, 5 to 30 mm.

The waterproof screw 1 obtained in this manner includes the screw member 2 including the head portion 3 and the shank portion 4 and the sealing material 5 covering the circumference of the shank portion 4, and the sealing material 5 in the inner side in the radial direction of the shank portion 4 has a shear storage elastic modulus G′ at 25° C. measured at a frequency of 1 Hz of 50000 Pa or less. Thus, when a structure (described later) is fixed to a roof using the above-described waterproof screw 1, the sealing material 5 is capable of sealing an insertion portion in the roof for the shank portion 4, so that the infiltration of water into the inside of the roof is capable of being sufficiently suppressed.

On the other hand, in the waterproof screw 1, when the tackiness of the surface at the outermost surface of the sealing material 5 is high, for example, there is a disadvantage that the blocking (the adhesion of the sealing materials 5 to each other) of the waterproof screws 1 with each other occurs due to the contact of the sealing materials 5 at the time of transportation or the like.

Also, when the tackiness of the surface of the sealing material 5 is high, the handling ability may be poor in such as a case where the adhesion of the sealing material 5 to a hand or the like of an operator occurs at the time of an installation operation of installing a structure (described later) on a roof.

On the other hand, in order to solve such a disadvantage, it is considered that, for example, a release paper or the like is provided at the surface of the sealing material 5. When the sealing material 5 is provided, the blocking or the adhesion of the sealing material 5 to a hand or the like of an operator are capable of being prevented. In this case, however, there may be a case where a release paper is required to be peeled at the time of an installation operation of installing a structure (described later) on a roof, so that the number of operation steps is increased and the workability is poor.

In contrast, in the above-described waterproof screw 1, in the sealing material 5, the tackiness of the surface at the outer side in the radial direction of the shank portion 4 is lower than that of the surface at the inner side in the radial direction thereof (preferably, tack-free), so that the blocking resistance is excellent and the blocking (the adhesion of the sealing materials 5 to each other) of the waterproof screws 1 with each other at the time of transportation or the like is capable of being suppressed. Furthermore, the above-described waterproof screw 1 has excellent handling ability, so that the adhesion of the sealing material 5 to a hand or the like of an operator is capable of being suppressed at the time of an installation operation of installing a structure (described later) on a roof.

Thus, in the above-described waterproof screw 1, a release paper is not required and a step of peeling the release paper is capable of being omitted at the time of an installation operation of installing a structure (described later) on a roof, so that a smooth installation operation of the structure (described later) is capable of being achieved, that is, the improvement of the workability is capable of being achieved.

The waterproof screw 1 can be used so as to install the structure 8 on, for example, a roof 9 of a building.

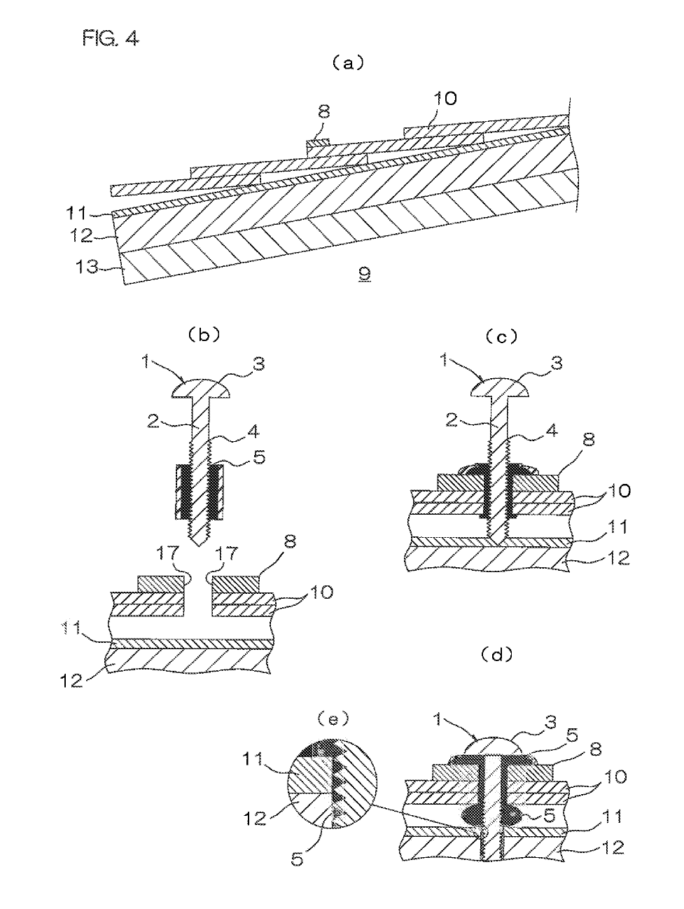

FIG. 4 shows explanatory views for illustrating one embodiment of a method for structure installation of the present invention in which a structure is installed on a roof of a building: (a) illustrating a structure disposing step of disposing the structure on the roof and (b) to (e) illustrating a structure fixing step of fixing the structure to the roof by the waterproof screw shown in FIG. 1.

In order to install the structure 8 on the roof 9, first, the structure 8 is disposed on the roof 9 (the structure disposing step).

The structure 8 is not particularly limited and an example thereof includes a fitting (a roof mount or the like) for fixing a solar cell module, an outdoor unit of air conditioner, or the like to the roof.

In the roof 9, for example, as shown in FIG. 4 (a), a roofing board 12 as a backing board is laminated on a rafter 13 and a roofing material 11 as a waterproof sheet is laminated on the roofing board 12. Slates 10 are disposed in step-like arrangement on the roofing material 11 and a space (a gap) is formed between the roofing material 11 and the slates 10.

The structure 8 is first disposed on the slate 10.

Next, the structure 8 is fixed to the roof 9 by the waterproof screw shown in FIG. 1 (the structure fixing step).

In order to fix the structure 8 to the roof 9, first, as shown in FIG. 4 (b), through holes 17 are provided in the structure 8 and in the slates 10 of the roof 9 so as to allow the shank portion 4 of the screw member 2 to insert thereinto.

In the formation of the through holes 17, a known perforation method is used.

A prepared hole can be also provided in the roofing material 11 as required.

The diameter of each of the through holes 17 is larger than that of the shank portion 4 and preferably, is smaller than the sum total of the diameter of the shank portion 4 and the thickness of the sealing material 5, or more preferably, is smaller than the sum total of the diameter of the shank portion 4 and the thickness of the inner-side elastic layer 6.

As shown in FIG. 4 (c), the shank portion 4 with its circumference covered with the sealing material 5 is allowed to insert into the through holes 17.

When the diameter of each of the through holes 17 is smaller than the sum total of the diameter of the shank portion 4 and the thickness of the inner-side elastic layer 6, a part of the inner-side elastic layer 6 covering the circumference of the shank portion 4 and the outer-side elastic layer 7 are brought into contact with the upper surface of the structure 8 at the time of insertion. Thus, the inner-side elastic layer 6 and the outer-side elastic layer 7 that are in contact with the upper surface of the structure 8 are not allowed to insert into the inside of the through hole 17 and adhere to the upper surface of the through hole 17.

Along with this, the outer-side elastic layer 7 is slid along the surface (the interface between the inner-side elastic layer 6 and the outer-side elastic layer 7) of the inner-side elastic layer 6 to be integrated toward the side of the head portion 3.

On the other hand, the sealing material 5 (the inner side) that is not in contact with the upper surface of the structure 8 passes through the inside of the through holes 17, while covering the circumference of the shank portion 4, to then reach the space between the roofing material 11 and the slates 10.

Next, as shown in FIG. 4 (d), the waterproof screw 1 is screwed in. In this way, a screw hole is formed in the roofing material 11 and the shank portion 4 is screwed together with the roofing material 11 and the roofing board 12. In this way, the structure 8 is fixed to the roof 9 by the waterproof screw 1.

Thereafter, though not shown, a solar cell module, an outdoor unit of air conditioner, or the like is installed in the fitting.

As shown in FIG. 4 (e), at the time of screwing the shank portion 4 together with the roofing material 11 and the roofing board 12, the sealing material 5 (the inner-side elastic layer 6) that adheres to the screw thread (the screw groove) portion formed in the shank portion 4 is put into the inside of the screw hole with the shank portion 4, while covering the shank portion 4.

Thus, the sealing material 5 (the inner-side elastic layer 6) that adheres to the screw thread (the screw groove) portion is interposed between the shank portion 4, and the roofing material 11 and the roofing board 12 to seal a screwed portion for the shank portion 4.

On the other hand, at the time of forming the screw hole, the sealing material 5 (the inner-side elastic layer 6) that adheres to a portion other than the screw thread (the screw groove) portion is not put into the inside of the screw hole due to the resistance of the roofing material 11 and adheres to the upper surface of the screw hole. Thus, the upper surface of the screw hole is sealed.

The sealing material 5 (the inner-side elastic layer 6 and the outer-side elastic layer 7) that adheres to the upper surface of the through hole 17 is sandwiched between the head portion 3 of the screw member 2 and the structure 8, so that it seals the upper surface of the through hole 17.

In this way, the upper surface of the through hole 17 provided in the structure 8, the insertion portion and the screwed portion for the shank portion 4, and the upper surface (the gap between the slate 10 and the roofing material 11) of the screw hole formed in the roofing material 11 are sealed.

In this way, the waterproof screw 1 includes the screw member 2 including the head portion 3 and the shank portion 4 and the sealing material 5 covering the circumference of the shank portion 4, and the sealing material 5 in the inner side in the radial direction of the shank portion 4 (the inner-side elastic layer 6) has a shear storage elastic modulus G′ at 25° C. and a frequency of 1 Hz of 50000 Pa or less.

The sealing material 5 has excellent adhesiveness to the shank portion 4 and therefore, even when the waterproof screw 1 is allowed to insert or is screwed together, the sealing material 5 is capable of sealing the insertion portion and the screwed portion without being peeled from the shank portion 4. Thus, as described above, when the structure 8 is fixed to the roof 9 using the waterproof screw 1, the sealing material 5 is capable of sealing the insertion portion and the screwed portion in the roof 9 for the shank portion 4 and furthermore, sealing the screw hole formed in the roofing material 11. As a result, the infiltration of water into the inside of the roof 9 is capable of being sufficiently suppressed.

Among all, since the above-described waterproof screw 1 has excellent blocking resistance and excellent handling ability, the above-described waterproof screw 1 is capable of fixing the structure 8 to the roof 9 with excellent workability and sufficiently suppressing the infiltration of water into the inside of the roof 9.

FIG. 5 shows a side view of another embodiment (an embodiment including a support layer) of a sealing material used in a waterproof screw of the present invention.

In the above-described description, the inner-side elastic layer 6 in the sealing material 5 is formed as one layer. Alternatively, for example, the inner-side elastic layer 6 can be formed as a plurality of layers. As shown in FIG. 5, for example, the inner-side elastic layer 6 can also include a support layer 23 so as to impart toughness to the inner-side elastic layer 6.

The support layer 23 is laminated so as to be sandwiched between the two inner-side elastic layers 6.

Examples of a material for forming the support layer 23 include a glass cloth, a resin impregnated glass cloth, a non-woven fabric, a metal foil, a carbon fiber, and a polyester film.

The glass cloth is cloth formed from a glass fiber and a known glass cloth is used.

The resin impregnated glass cloth is obtained by performing impregnation treatment of a synthetic resin such as a thermosetting resin and a thermoplastic resin into the above-described glass cloth and a known resin impregnated glass cloth is used. Examples of the thermosetting resin include an epoxy resin, a urethane resin, a melamine resin, and a phenol resin. Examples of the thermoplastic resin include a vinyl acetate resin, an ethylene-vinyl acetate copolymer (EVA), a vinyl chloride resin, and an EVA-vinyl chloride resin copolymer. The above-described thermosetting resins and thermoplastic resins can be used alone or in combination, respectively.

An example of the non-woven fabric includes a non-woven fabric formed of a fiber such as a wood fiber (a wood pulp and the like); a cellulose fiber (for example, a regenerated cellulose fiber such as rayon, a semi-synthetic cellulose fiber such as acetate, a natural cellulose fiber such as hemp and cotton, or a blended yarn thereof); a polyester fiber; a polyvinyl alcohol (PVA) fiber; a polyamide fiber; a polyolefin fiber; a polyurethane fiber; and a cellulose fiber (hemp, or hemp and another cellulose fiber).

An example of the metal foil includes a known metal foil such as an aluminum foil and a steel foil.

The carbon fiber is cloth formed from a fiber mainly composed of carbon and a known carbon fiber is used.

Examples of the polyester film include a polyethylene terephthalate film, a polyethylene naphthalate film, and a polybutylene terephthalate film. Preferably, a polyethylene terephthalate film is used.

Of the materials for forming the support layer 23, preferably, a non-woven fabric is used.

The support layer 23 has a thickness of, for example, 0.1 mm or more, and of, for example, 0.3 mm or less, or preferably 0.2 mm or less.

When the thickness of the support layer 23 is above 0.3 mm, the winding properties of the sealing material may be reduced. When the thickness thereof is less than 0.1 mm, the productivity of the sealing material may be reduced.

In order to prepare the inner-side elastic layer 6 including the support layer 23, the inner-side elastic layer 6 is laminated on the surface of the first release paper 21 or the like and thereafter, the above-described support layer 23 is attached to the surface that is the opposite side to the laminated side of the first release paper 21 of the inner-side elastic layer 6. Then, the inner-side elastic layer 6 is again laminated on the support layer 23.

By laminating the outer-side elastic layer 7 on the inner-side elastic layer 6 that is laminated in this way in the same manner as that described above, the sealing material 5 is capable of being obtained.

When the sealing material 5 is wound around the shank portion 4, the inner-side elastic layer 6 that is the opposite side of the outer-side elastic layer 7 with respect to the support layer 23 is in contact with the screw thread (the screw groove) of the shank portion 4 and the inner-side elastic layer 6 at the side of the outer-side elastic layer 7 with respect to the support layer 23 is covered with the outer-side elastic layer 7.

### EXAMPLES

The present invention will now be described in more detail by way of Preparation Examples, Examples, and Comparative Examples. However, the present invention is not limited to the following Preparation Examples, Examples, and Comparative Examples.

### Preparation Examples 1 to 6

### Preparation of Kneaded Material

Kneaded materials (pressure-sensitive adhesive compositions or low pressure-sensitive adhesive compositions) were obtained by blending the components and kneading the mixture (at 120° C. for 20 minutes) with a mixing roll in accordance with the mixing formulation shown in Table 1.

(Evaluation)

A viscoelasticity test and a peel adhesive property test of each of the kneaded materials obtained in Preparation Examples were performed as follows. The results are shown in Table 1.

(1) Viscoelasticity Test

Each of the kneaded materials obtained in Preparation Examples was extended by applying pressure into a sheet shape having a thickness of 3 mm by a press molding (at 120° C. for 10 minutes) to be processed into a cylindrical shape having a diameter of 7.9 mm, so that test pieces were obtained.

Next, the shear storage elastic modulus G′ and the shear loss elastic modulus G″ at 25° C. of the obtained test pieces were calculated, respectively with a viscoelasticity measuring device (trade name: ARES, manufactured by Rheometric Scientific Inc.).

The measuring conditions were set to be as follows: a measurement temperature range of 0 to 120° C., a temperature rising rate of 5° C./min, a frequency of 1 Hz, and a distortion of 0.1%.

(2) Peel Adhesive Property Test

Each of the kneaded materials obtained in Preparation Examples was extended by applying pressure into a sheet shape having a thickness of 0.5 mm by a press molding (at 120° C. for 10 minutes). The obtained sheet was attached to a PET film that was not subjected to a release treatment and had a thickness of 25 μm to be lined. The resulting sheet was cut into pieces each having a width of 25 mm to obtain samples.

Next, the sample was compressively bonded to a stainless steel board, as an adherend, (SUS board, BA430 board) that was cleansed with toluene by one reciprocation of 2-kg roller at 23° C. to be allowed to stand for 30 minutes. Thereafter, the peel pressure-sensitive adhesive force was measured with a tensile testing machine (model number: Autograph AG-X200H, manufactured by Shimadzu Corporation) under an atmosphere of 23° C. under the conditions of a rate of 300 mm/min and a peel angle of 180°.

TABLE 1

| Prep. Ex. No. | | Prep. Ex. 1 | Prep. Ex. 2 | Prep. Ex. 3 | Prep. Ex. 4 | Prep. Ex. 5 | Prep. Ex. 6 |
|---|---|---|---|---|---|---|---|
| Mixing | Reclaimed | 100 | 100 | 100 | 50 | 50 | 50 |
| Formulation | Butyl Rubber | | | | | | |
| (Parts | EPDM | — | — | — | 50 | 50 | 50 |
| by Mass) | Polybutene | 100 | 100 | 100 | — | — | — |
| | Process Oil | — | — | — | 10 | 30 | 10 |
| | Calcium | 100 | 200 | 300 | 100 | 150 | 100 |
| | Carbonate | | | | | | |
| | C5 Tackifier | 50 | 50 | 50 | — | — | 50 |
| | Quinoid | 2 | 2 | 2 | — | — | — |
| | Cross-Linking | | | | | | |
| | Agent | | | | | | |
| Evaluation | Storage | 16556 | 36217 | 58256 | 524610 | 392690 | 344790 |
| | Elastic | | | | | | |
| | Modulus (Pa) | | | | | | |
| | Loss Elastic | 10157 | 17393 | 26489 | 115920 | 99869 | 143740 |
| | Modulus (Pa) | | | | | | |
| | Peel Adhesive | 19.2 | 18.2 | 15.0 | 0.2 | 0.3 | 34.5 |
| | Force to SUS | | | | | | |
| | Board (N/25 | | | | | | |
| | mm) | | | | | | |

Abbreviations of the components in Table 1 are shown in the following.

Reclaimed butyl rubber: a Mooney viscosity of 44 (±6) (ML 1+4, 100° C.)

EPDM: an ethylene-propylene-diene rubber, ESPRENE 600F (manufactured by SUMITOMO CHEMICAL Co., Ltd.)

Polybutene: a liquid rubber, Polybutene HV-300, a kinetic viscosity of 600 mm²/s (at 100° C.) (manufactured by Nippon Petrochemicals Co., Ltd.)

Process oil: a softener, Diana Process Oil PW-90 (manufactured by Idemitsu Kosan Co., Ltd.)

Calcium carbonate: a filler, heavy calcium carbonate (manufactured by MARUO CALCIUM CO., LTD.)

C5 tackifier: a tackifier, ESCOREZ 1202 (manufactured by Exxon Mobil Corporation)

Quinoid cross-linking agent: a cross-linking agent, VULNOC DNB (manufactured by OUCHI SHINKO CHEMICAL INDUSTRIAL CO., LTD.)

### Examples 1 to 4 and Comparative Examples 1 to 5

Each of the kneaded materials obtained in Preparation Examples was extended by applying pressure into a sheet shape by a press molding (at 120° C. for 10 minutes) to be laminated on the surfaces of release papers (the first release paper 21 and the second release paper 22), so that the inner-side elastic layer 6 and the outer-side elastic layer 7 were prepared. The inner-side elastic layer 6 had a thickness of 1.0 mm and the outer-side elastic layer 7 had a thickness of 0.5 mm.

By attaching the inner-side elastic layer 6 to the outer-side elastic layer 7 by combinations shown in Table 2, the sealing material 5 having a thickness of 1.5 mm was prepared.

Then, the sealing material 5 was peeled from the release paper and the sealing material 5 was wound around the shank portion 4 of the screw member 2 by one round so that the inner-side elastic layer 6 was in contact with the shank portion 4 of the screw member 2 and the outer-side elastic layer 7 was located at the outermost layer (the topmost surface). The sealing material 5 was wound around the shank portion 4 at a position of 10 to 30 mm from the end portion of the screw member 2 with the length in the axial direction of the sealing material 5 of 20 mm.

(Evaluation)

A screw adhesiveness test, a roofing material adhesiveness test, and a water stopping test of screw of each of the waterproof screws 1 obtained in Examples and Comparative Examples were performed as follows. The results are shown in Table 2.

(1) Screw Adhesiveness Test

Each of the waterproof screws 1 obtained in Examples and Comparative Examples was allowed to pass through a laminated board of the roofing material 11 (a thickness of 2 mm) and the roofing board 12 (a thickness of 20 mm), and the adhesiveness between the shank portion 4 of the screw member 2 that passed through the laminated board and the sealing material 5 was confirmed.

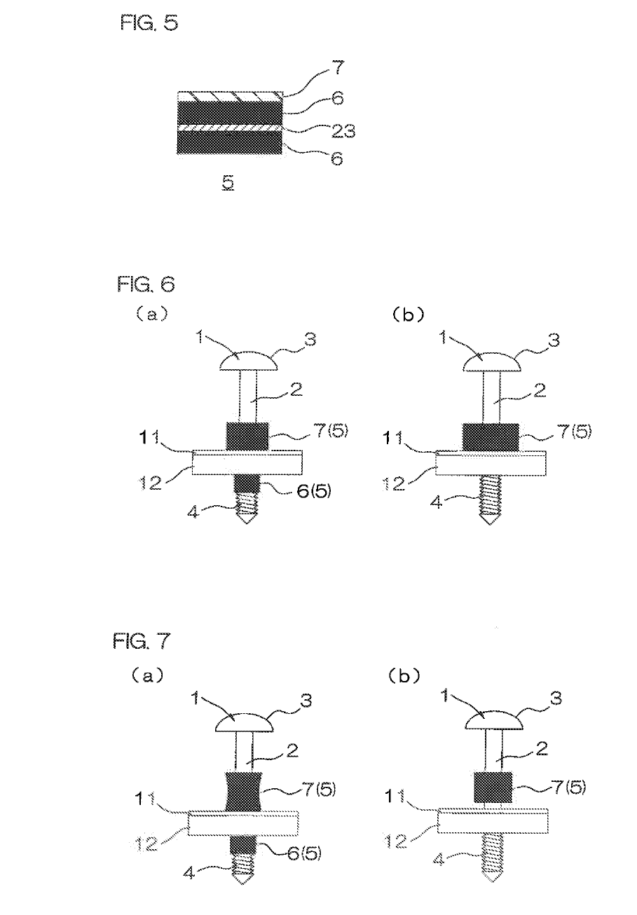

As shown in FIG. 6 (a), when the sealing material 5 covered the shank portion 4 of the screw member 2 that passed through the laminated board, the screw adhesiveness was defined as “Good”. As shown in FIG. 6 (b), when the sealing material 5 failed to cover the shank portion 4 of the screw member 2 that passed through the laminated board, the screw adhesiveness was defined as “Bad”.

(2) Roofing Material Adhesiveness Test

Each of the waterproof screws 1 obtained in Examples and Comparative Examples was allowed to pass through a laminated board of the roofing material 11 (a thickness of 2 mm) and the roofing board 12 (a thickness of 20 mm). Thereafter, the waterproof screw 1 was screwed back and the adhesiveness between the roofing material 11 and the sealing material 5 was confirmed.

As shown in FIG. 7 (a), in a case where the sealing material 5 expanded and failed to separate from the roofing material 11 even when the waterproof screw 1 was screwed back, the roofing material adhesiveness was defined as “Good”. As shown in FIG. 7 (b), in a case where the sealing material 5 separated from the roofing material 11 when the waterproof screw 1 was screwed back, the roofing material adhesiveness was defined as “Bad”.

(3) Test for Blocking Resistance During Storage

The two waterproof screws 1 were fixed so that the sealing materials 5 (the outer-side elastic layers 7) thereof were in tight contact with each other to be allowed to stand still at 40° C. for 24 hours. Thereafter, the two waterproof screws 1 were separated from each other. At this time, a case where the two waterproof screws 1 were easily separated was defined as “Good”. A case where the sealing materials 5 adhered to each other and failed to be separated and a case where the sealing material 5 was floated from the shank portion 4 at the time of separation were defined as “Bad”.

(4) Water Stopping Test of Screw

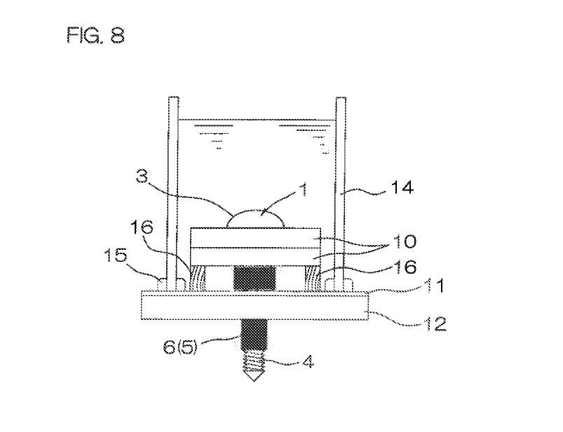

As shown in FIG. 8, each of the waterproof screws 1 obtained in Examples and Comparative Examples was allowed to insert into the slates 10 (two pieces) (a thickness of 6 mm) in which through holes 17 each having a diameter of 7 mm were provided to be then allowed to pass through a laminated board of the roofing material 11 (a thickness of 2 mm) and the roofing board 12 (a thickness of 20 mm). At this time, an interval of 6 mm was provided between the slates 10 and the roofing material 11 via wood block spacers 16. Next, a transparent acrylic tube 14 (a height of 200 mm and a diameter of 76.5 mm) was disposed on the laminated board so as to surround the head portion 3 of the screw member 2 and the slates 10. Then, the laminated board and the transparent acrylic tube 14 were bonded to each other by silicone caulking 15. Next, the inside of the transparent acrylic tube 14 was filled with water obtained by dissolving an aqueous ink therein so as to have a depth of 150 mm to be then allowed to stand for 24 hours.

24 hours later, the presence or absence of water leakage between the roofing material 11 and the roofing board 12 was confirmed to evaluate the water stopping performance of screw.

TABLE 2

| Ex. No. | | Ex. 1 | Ex. 2 | Ex. 3 | Ex. 4 |
|---|---|---|---|---|---|
| Inner-Side | Prep. Ex. No. | Prep. Ex. 1 | Prep. Ex. 1 | Prep. Ex. 2 | Prep. Ex. 2 |
| Elastic Layer | Thickness (mm) | 1.0 | 1.0 | 1.0 | 1.0 |
| Outer-Side | Prep. Ex. No. | Prep. Ex. 4 | Prep. Ex. 5 | Prep. Ex. 4 | Prep. Ex. 5 |
| Elastic Layer | Thickness (mm) | 0.5 | 0.5 | 0.5 | 0.5 |
| Evaluation | Screw | Good | Good | Good | Good |
| | Adhesiveness | | | | |
| | Roofing Material | Good | Good | Good | Good |
| | Adhesiveness | | | | |
| | Blocking | Good | Good | Good | Good |
| | Resistance during | | | | |
| | Storage | | | | |
| | Water Stopping | Absence of | Absence of | Absence of | Absence of |
| | Test of Screw | Water Leakage | Water Leakage | Water Leakage | Water Leakage |
| | (24 hours) | | | | |

| Comp. Ex. No. | | Comp. Ex. 1 | Comp. Ex. 2 | Comp. Ex. 3 | Comp. Ex. 4 | Comp. Ex. 5 |
|---|---|---|---|---|---|---|
| Inner-Side | Prep. Ex. No. | Prep. Ex. 3 | Prep. Ex. 1 | Prep. Ex. 1 | Prep. Ex. 3 | Prep. Ex. 4 |
| Elastic Layer | Thickness (mm) | 1.0 | 1.0 | 1.0 | 1.0 | 1.0 |
| Outer-Side | Prep. Ex. No. | Prep. Ex. 4 | Prep. Ex. 1 | Prep. Ex. 6 | Prep. Ex. 6 | Prep. Ex. 4 |
| Elastic Layer | Thickness (mm) | 0.5 | 0.5 | 0.5 | 0.5 | 0.5 |
| Evaluation | Screw | Bad | Good | Good | Bad | Bad |
| | Adhesiveness | | | | | |
| | Roofing Material | Bad | Good | Good | Bad | Bad |
| | Adhesiveness | | | | | |
| | Blocking | Good | Bad | Bad | Bad | Good |
| | Resistance during | | | | | |
| | Storage | | | | | |
| | Water Stopping | Presence of | Absence of | Absence of | Presence of | Presence of |
| | Test of Screw | Water Leakage | Water Leakage | Water Leakage | Water Leakage | Water Leakage |
| | (24 hours) | | | | | |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The waterproof screw, the sealing material, the method for structure installation, and the structure for structure installation of the present invention can be used to install a structure on a roof of a building or the like.

1. A waterproof screw comprising:
a screw member including a head portion and a shank portion and
a sealing material covering the circumference of the shank portion, wherein
in the sealing material, the tackiness of a surface at the outer side in a radial direction of the shank portion is lower than that of a surface at the inner side in the radial direction thereof and
the inner side in the radial direction of the sealing material has a shear storage elastic modulus G′ at 25° C. measured at a frequency of 1 Hz of 50000 Pa or less.

2. The waterproof screw according to claim 1, wherein
the sealing material includes
an inner-side elastic layer in contact with the shank portion and
an outer-side elastic layer laminated at the outer side in the radial direction of the inner-side elastic layer,
the inner-side elastic layer has a shear storage elastic modulus G′ at 25° C. measured at a frequency of 1 Hz of 50000 Pa or less, and
the shear storage elastic modulus G′ of the outer-side elastic layer is higher than that of the inner-side elastic layer.

3. The waterproof screw according to claim 2, wherein
the outer-side elastic layer has a shear storage elastic modulus G′ at 25° C. measured at a frequency of 1 Hz of 1000000 Pa or less.

4. The waterproof screw according to claim 2 or 3, wherein
the inner-side elastic layer has a 180° peel adhesive force at 23° C. with respect to a stainless steel board of 5 N/25 mm or more.

5. The waterproof screw according to any one of claims 2 to 4, wherein
the outer-side elastic layer has a 180° peel adhesive force at 23° C. with respect to a stainless steel board of 1 N/25 mm or less.

6. The waterproof screw according to any one of claims 2 to 5, wherein
the inner-side elastic layer contains a butyl rubber.

7. The waterproof screw according to any one of claims 2 to 6, wherein
the outer-side elastic layer contains a synthetic rubber and/or a resin.

8. The waterproof screw according to claim 7, wherein
the synthetic rubber is an ethylene-propylene-diene rubber.

9. The waterproof screw according to any one of claims 6 to 8, wherein
the inner-side elastic layer further contains a liquid rubber and a filler and
the mixing ratio of the filler with respect to 100 parts by mass of the butyl rubber is less than 300 parts by mass.

10. The waterproof screw according to any one of claims 1 to 9, wherein
the waterproof screw is used so as to install a structure on a roof.

11. A sealing material covering a shank portion of a screw member to be used so as to seal an insertion portion for the shank portion, wherein
in a state of covering the shank portion,
the tackiness of a surface at the outer side in a radial direction of the shank portion is lower than that of a surface at the inner side in the radial direction thereof and
the inner side in the radial direction of the sealing material has a shear storage elastic modulus G′ at 25° C. measured at a frequency of 1 Hz of 50000 Pa or less.

12. A method for structure installation installing a structure on a roof comprising:
a structure disposing step of disposing the structure on the roof and
a structure fixing step of fixing the structure to the roof by the waterproof screw according to any one of claims 1 to 10.

13. A structure for structure installation in which a structure is installed on a roof, wherein
the structure is disposed on the roof and
the structure is fixed to the roof by the waterproof screw according to any one of claims 1 to 10.
